(19) United States
(12) Patent Application Publication
(10) Pub. No.: US 2005/0106081 A1
(43) Pub. Date: May 19, 2005

(54) Cleaning apparatus for removing impurities

(76) Inventor: Yao-Chang Lin, Taichung City (TW)

Correspondence Address: FROMMER LAWRENCE & HAUG, 745 FIFTH AVENUE- 10TH FL., NEW YORK, NY, 10151, US

(21) Appl. No.: 10/714,098

(22) Filed: Nov. 14, 2003

(51) Int. Cl. B01D 53/34

(52) U.S. Cl. 422/171; 422/168

(57) ABSTRACT

A cleaning apparatus for removing impurities from exhaust gas includes a gas treating pipe, a liquid supplier, an exhaust gas pipe, and a liquid outlet. The gas treating pipe has an upper section, a lower section, and an intermediate section extending from the lower section to the upper section. The intermediate section has a plurality of bent parts. The upper section has a gas exit. The liquid supplier is fluidly communicated with the upper section of the gas treating pipe below the gas exit. The exhaust gas pipe is connected to the lower section of the gas treating pipe. The liquid outlet is provided at the lower section of the gas treating pipe.

### BACKGROUND OF THE INVENTION

1. Field of the Invention

The invention relates to a cleaning apparatus, more particularly to a cleaning apparatus for removing impurities from exhaust gas by contacting the exhaust gas in a bubble form with liquid.

2. Description of the Related Art

The fuel, such as diesel, coal, and the like, used in diesel engines, boilers, and the like will produce a great amount of exhaust gas after combustion, which is a major source of air pollution, and which is harmful to human beings. Therefore, it is desired to effectively treat the exhaust gas so as to meet the requirements of environmental protection.

One of the conventional methods for treating the exhaust gas is to provide a filter for a gas treating pipe. However, the filter can merely separate particulate impurities from the exhaust gas. Most of the gaseous impurities can not be effectively filtered out of the exhaust gas by the filter. Another conventional method for treating the exhaust gas is to provide a water-spraying device for the gas treating pipe, which sprays water droplets that combine with the exhaust gas so as to reduce the opportunity of discharging the exhaust gas into the atmosphere. Although the water-spraying device can reduce the amount of the exhaust gas, the exhaust gas can not be completely combined with the water droplets. Some of the exhaust gas may be discharged from the gas treating pipe without treatment. Therefore, it is desirable to further improve the cleaning effect achieved by the water-spraying device.

### SUMMARY OF THE INVENTION

Therefore, the object of the present invention is to provide a cleaning apparatus for removing impurities from exhaust gas, which can achieve superior cleaning effect over those achieved by the prior art.

A cleaning apparatus for removing impurities from exhaust gas according to this invention includes a gas treating pipe, a liquid supplier, an exhaust gas pipe, and a liquid outlet. The gas treating pipe has an upper section, a lower section, and an intermediate section extending from the lower section to the upper section. The intermediate section has a plurality of bent parts. The upper section has a gas exit. The liquid supplier is fluidly communicated with the upper section of the gas treating pipe below the gas exit. The exhaust gas pipe is connected to the lower section of the gas treating pipe. The liquid outlet is provided at the lower section of the gas treating pipe.

### BRIEF DESCRIPTION OF THE DRAWINGS

Other features and advantages of the present invention will become apparent in the following detailed description of the preferred embodiments with reference to the accompanying drawings, of which:

FIG. 1 is a partly exploded fragmentary perspective view of the first preferred embodiment of the cleaning apparatus for removing impurities from exhaust gas according to this invention;

FIG. 2 is a fragmentary schematic view of the first preferred embodiment;

FIG. 3 is a fragmentary schematic view of the first preferred embodiment, showing a state in which exhaust gas is treated by contacting it in a bubble form with liquid;

FIG. 4 is a fragmentary schematic view of the first preferred embodiment, showing a state in which a removable end part is removed for cleaning;

FIG. 5 is a fragmentary perspective view of the second preferred embodiment of the cleaning apparatus for removing impurities from exhaust gas according to this invention;

FIG. 6 is a schematic view of the second preferred embodiment; and

FIG. 7 is a fragmentary perspective view of the third preferred embodiment of the cleaning apparatus for removing impurities from exhaust gas according to this invention.

### DETAILED DESCRIPTION OF THE PREFERRED EMBODIMENT

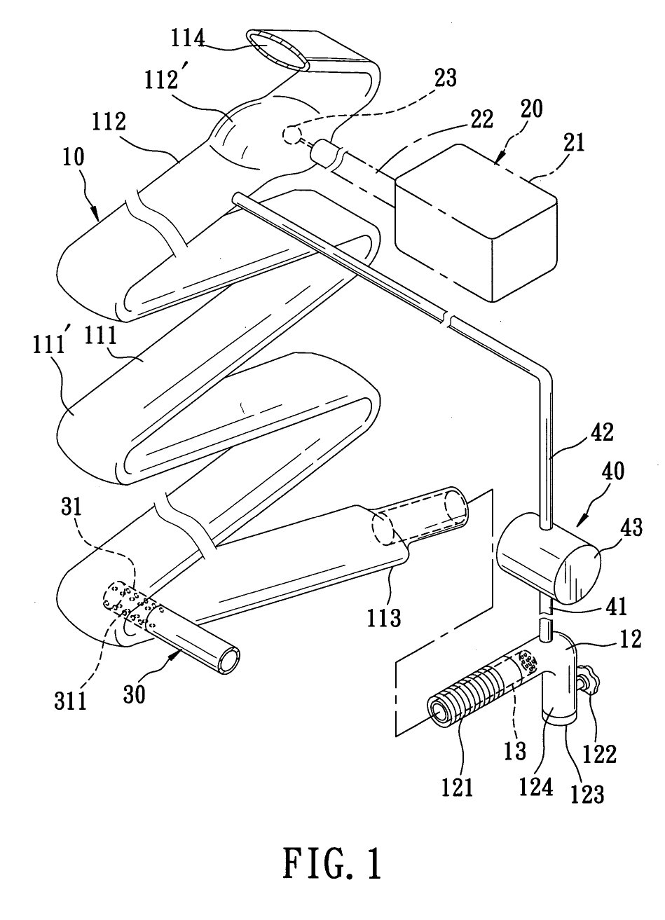

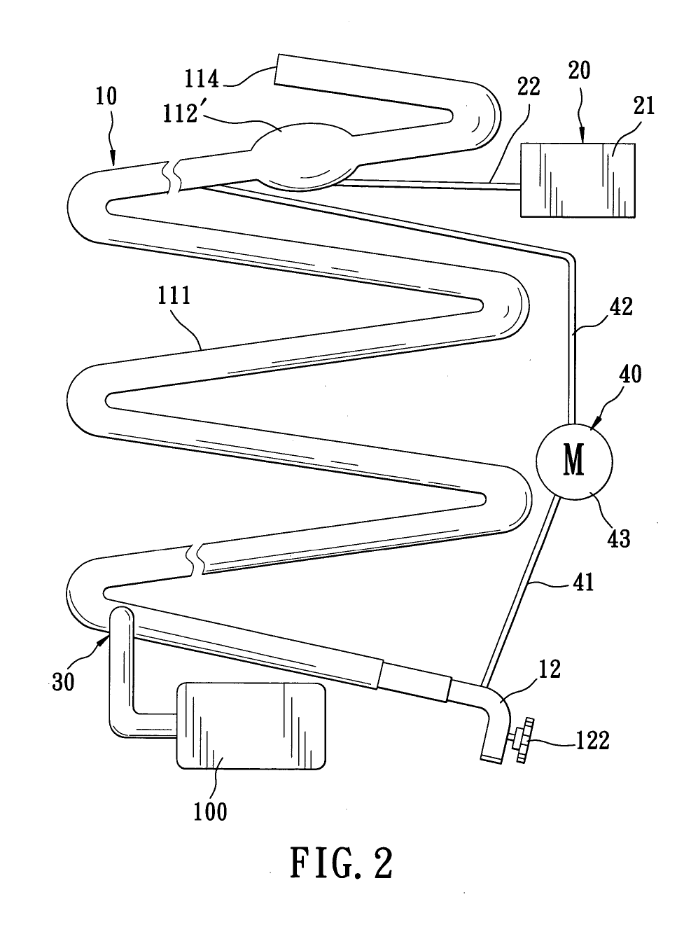

Referring to FIGS. 1, 2 and 3, the cleaning apparatus for removing impurities from exhaust gas according to this invention includes a gas treating pipe 10, a liquid supplier 20, an exhaust gas pipe 30, a liquid outlet 123, and a liquid recirculating member 40.

The gas treating pipe 10 includes an upper section 112, a lower section 113, and an intermediate section 111 extending from the lower section 113 to the upper section 112. The intermediate section 111 has a plurality of bent parts 111′. The upper section 112 has a gas exit 114. The liquid outlet 123 is provided at the lower section 113 of the gas treating pipe 10. In this embodiment, the gas treating pipe 10 is formed in a zig-zag shape. The lower section 113 of the gas treating pipe 10 includes a removable end part 12, which has an upstream end 121 attached removably to the lower section 113 of the gas treating pipe 10, and a downstream end 124 provided with the liquid outlet 123. The lower section 113 of the gas treating pipe 10 further includes a valve 122 for controlling fluid flow through the liquid outlet 123, and a filter 13 disposed in the removable end part 12 adjacent to the upstream end 121. The upper section 112 of the gas treating pipe 10 has an expanded chamber 112′.

The liquid supplier 20 is fluidly communicated with the upper section 112 of the gas treating pipe 10 below the gas exit 114. The liquid supplier 20 includes a liquid tank 21 that contains liquid 24 therein for absorbing the impurities of the exhaust gas, a liquid charging pipe 22 connected between the liquid tank 21 and the expanded chamber 112′ of the upper section 112 of the gas treating pipe 10, and a liquid level detector 23 extending into the expanded chamber 112′ of the upper section 112 of the gas treating pipe 10 for producing a signal to activate the liquid supplier 20 to supply the liquid 24 into the gas treating pipe 10 when a liquid level in the gas treating pipe 10 is lower than a predetermined level. The liquid 24 used in the preferred embodiment is water. Of course, a proper amount of any suitable additives commonly used in the art can be added to the liquid 24, if desired, so as to enhance the cleaning effect of the liquid 24.

The exhaust gas pipe 30 is connected between the lower section 113 of the gas treating pipe 10 and an engine 100. The exhaust gas pipe 30 includes a bubble forming section 31 extending into the lower section 113 of the gas treating pipe 10. The bubble forming section 31 has a plurality of pores 311 for forming the exhaust gas into bubbles in the gas treating pipe 10 so as to treat the exhaust gas in a bubble form with the liquid 24. A check valve (not shown) can be provided between the exhaust gas pipe 30 and the engine 100 so as to prevent the liquid 24 from flowing into the engine 100.

The liquid recirculating member 40 has opposite first and second end portions 41,42 connected respectively to the lower and upper sections 113,112 of the gas treating pipe 10 for recycling the liquid 24, and a pump 43 connected between the first and second end portions 41,42. Preferably, the first end portion 41 of the liquid recirculating member 40 is connected to the removable end part 12 of the gas treating pipe 10 at a position between the filter 13 and the valve 122 so as to recirculate the liquid purified by the filter 13 into the gas treating pipe 10 through the pump 43 and the second end portion 42 of the liquid recirculating member 40. The liquid level detector 23 extends into the upper section 112 of the gas treating pipe 10 at a level higher than the second end portion 42 of the liquid recirculating member 40.

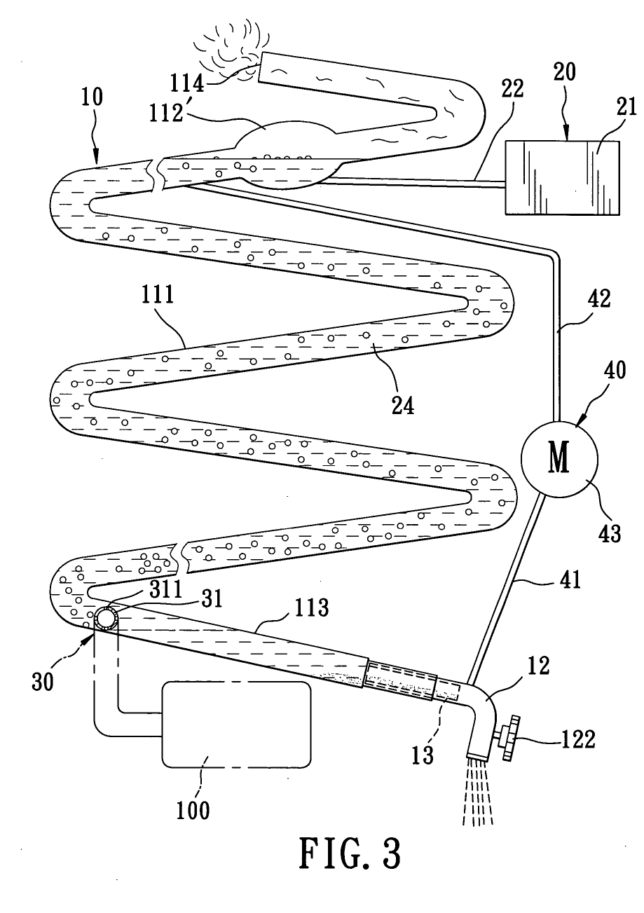

Specifically referring to FIG. 3, when the engine 100 is activated, the exhaust gas discharged from the engine 100 flows into the lower section 113 of the gas treating pipe 10 through the exhaust gas pipe 30. After passing through the pores 311 in the bubble forming section 31, the exhaust gas is treated by contacting it in a bubble form with the liquid 24. Since the gas treating pipe 10 is formed in a zig-zag shape, the duration for contacting the exhaust gas with the liquid 24 is increased considerably. Therefore, impurities, such as particles and poisonous material, contained in the exhaust gas can be effectively removed by the liquid 24. The exhaust gas cleaned by the liquid 24 is discharged into the atmosphere through the gas exit 114. The impurities can be filtered out of the used liquid 24 by the filter 13 so that the liquid 24 purified by the filter 13 can be recirculated into the gas treating pipe 10 through the pump 43 and the second end portion 42 of the liquid recirculating member 40.

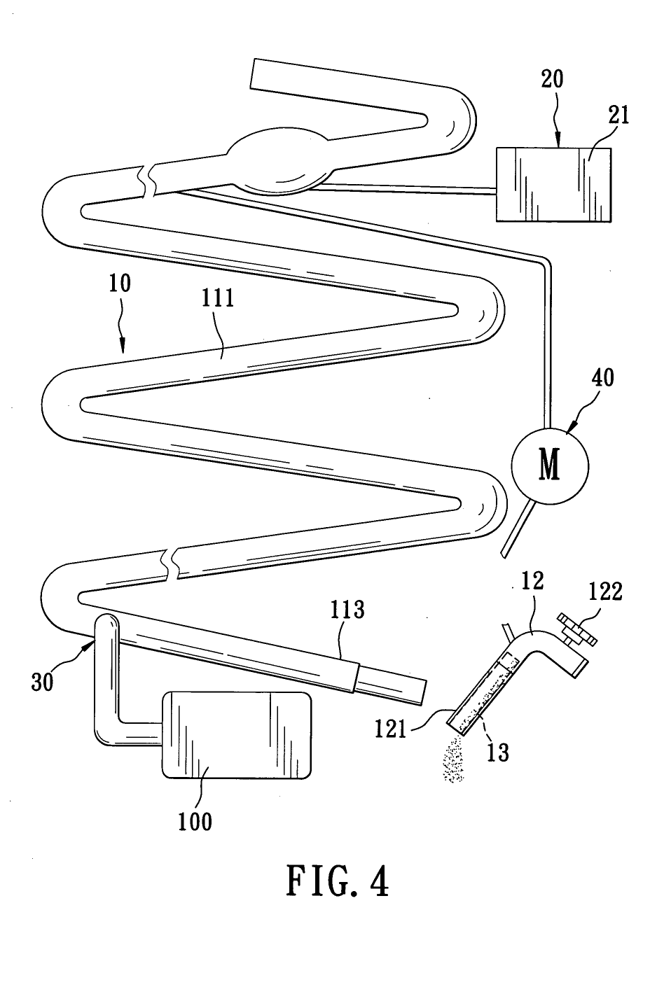

Referring to FIG. 4, the impurities accumulated on the filter 13 can be cleaned out by opening the valve 122 to discharge the liquid 24 from the gas treating pipe 10 into a container (not shown) and by disengaging the removable end part 12 from the lower section 113 of the gas treating pipe 10 so as to clean the filter 13. The filter 13, after being cleaned, can be disposed back into the removable end part 12, which is then re-connected to the lower section 113 of the gas treating pipe 10.

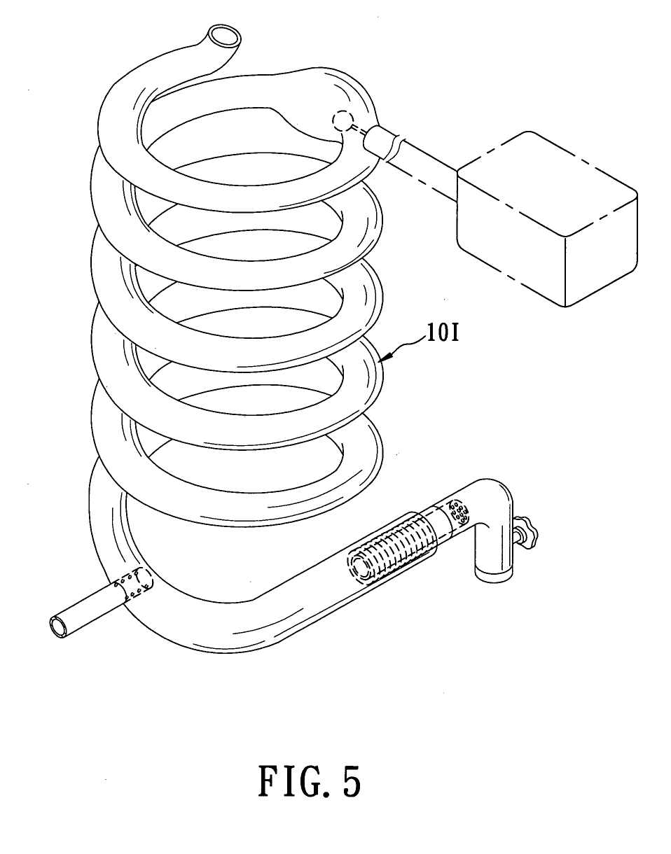

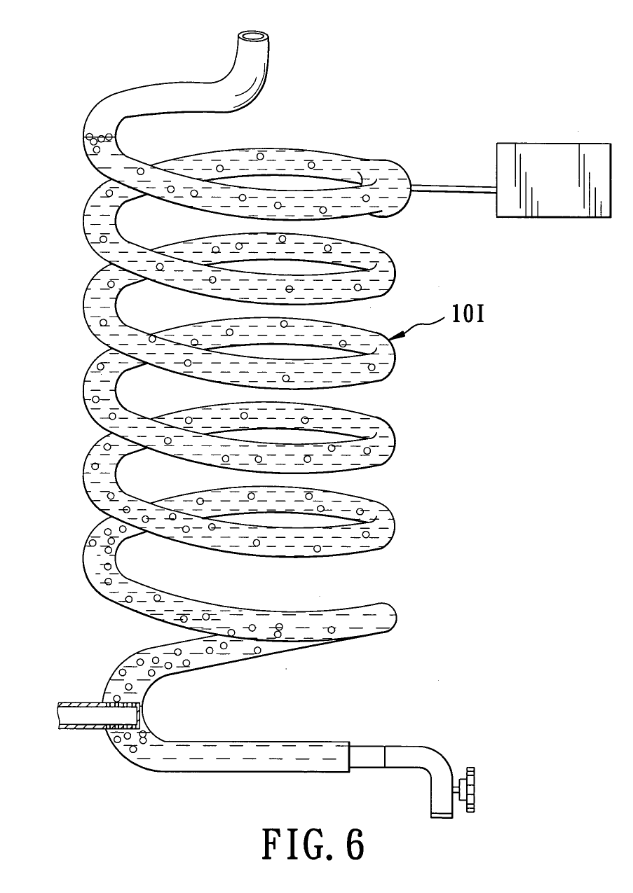

Referring to FIGS. 5 and 6, the second preferred embodiment of the cleaning apparatus according to this invention is shown to be similar to the previous embodiment, that main difference residing in that the gas treating pipe 10I is formed as a coil. Furthermore, the sectional shape of the gas treating pipe 10I is circular.

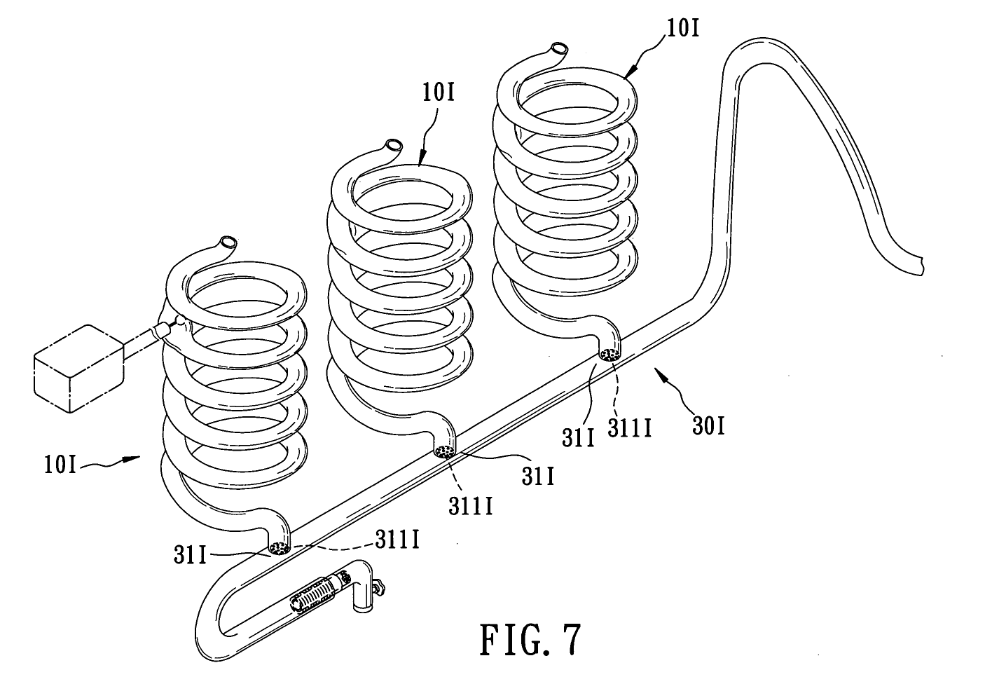

Referring to FIG. 7, the third preferred embodiment of the cleaning apparatus according to this invention is shown to include a plurality of gas treating pipes 10I and an exhaust gas pipe 30I. The exhaust gas pipe 30I has a plurality of bubble forming sections 31I corresponding respectively to the gas treating pipes 10I. Each of the bubble forming sections 31I is formed with a plurality of holes 311I to permit flow of the exhaust gas from the exhaust gas pipe 30I into the corresponding one of the gas treating pipes 10I.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A cleaning apparatus for removing impurities from exhaust gas, comprising:
a gas treating pipe including an upper section, a lower section, and an intermediate section extending from said lower section to said upper section, said intermediate section having a plurality of bent parts, said upper section having a gas exit;
a liquid supplier fluidly communicated with said upper section of said gas treating pipe below said gas exit;
an exhaust gas pipe connected to said lower section of said gas treating pipe; and
a liquid outlet provided at said lower section of said gas treating pipe.

2. The cleaning apparatus as claimed in claim 1, wherein said gas treating pipe is formed in a zig-zag shape.

3. The cleaning apparatus as claimed in claim 1, wherein said gas treating pipe is formed as a coil.

4. The cleaning apparatus as claimed in claim 1, wherein said lower section of said gas treating pipe includes: a removable end part which has an upstream end attached removably to said lower section of said gas treating pipe, and a downstream end provided with said liquid outlet; a valve for controlling fluid flow through said liquid outlet; and a filter disposed in said removable end part adjacent to said upstream end.

5. The cleaning apparatus as claimed in claim 1, wherein said liquid supplier includes water.

6. The cleaning apparatus as claimed in claim 1, wherein said exhaust gas pipe includes a bubble forming section extending into said lower section of said gas treating pipe, said bubble forming section having a plurality of pores for forming the exhaust gas into bubbles in said gas treating pipe.

7. The cleaning apparatus as claimed in claim 1, further comprising a liquid recirculating member having opposite first and second end portions connected respectively to said lower and upper sections of said gas treating pipe for recycling liquid, and a pump connected between said first and second end portions.

8. The cleaning apparatus as claimed in claim 7, wherein said liquid supplier further includes a liquid level detector extending into said upper section of said gas treating pipe at a level higher than said second end portion of said liquid recirculating member for producing a signal to activate said liquid supplier when a liquid level in said gas treating pipe is lower than a predetermined level.
